(19) United States
(12) Patent Application Publication
(10) Pub. No.: US 2016/0378315 A1
(43) Pub. Date: Dec. 29, 2016

(54) METHOD AND SYSTEM OF ADAPTING QUALITY FOR PRESENTING CONTENT ON A COMPUTING DEVICE

(71) Applicant: Calay Venture S.à r.l., Bettembourg (LU)

(72) Inventor: Cevat Yerli, Frankfurt am Main (DE)

(73) Assignee: Calay Venture S.à r.l., Bettembourg (LU)

(21) Appl. No.: 14/750,514

(22) Filed: Jun. 25, 2015

(51) Int. Cl. G06F 3/0484; G09G 5/391; G09G 5/00; G06F 3/16

(52) U.S. Cl. CPC G06F 3/04847; G06F 3/04842; G06F 3/165; G09G 5/391; G09G 5/005; G09G 2354/00; G09G 2320/0606

(57) ABSTRACT

A method of adapting quality for presenting content on a computing device, comprising detecting current display and/or audio settings of the computing device; detecting maximum possible display and/or audio settings of the computing device; and in response to determining a difference between the current and the maximum possible display and/or audio settings, prompting a user of the computing device for adjusting the current display and/or audio settings to different display and/or audio settings.

### TECHNICAL FIELD

The present disclosure relates to a method and system of adapting quality for presenting content on a computing device.

### BACKGROUND

Different types of devices allow for different levels of quality for presenting content on a computing device. Small computing devices, such as smart phones or tablet computers, generally have restricted quality settings. A screen of a computing device may be capable of displaying different screen sizes, such as 1024×768 pixels or 1920×800 pixels. The same screen may also be capable of displaying content at different resolutions. Typically, larger screens are capable of displaying larger screen sizes. Small screens may display low screen sizes but typically use higher resolutions. In many cases, content resolution is reduced on a small device in order to fit content dimensions to the small screen size.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A first aspect of the disclosure is a method of adapting quality for presenting content on a computing device, comprising: detecting current display and/or audio settings of the computing device; detecting maximum possible display and/or audio settings of the computing device; and, in response to determining a difference between the current and the maximum possible display and/or audio settings, prompting a user of the computing device for adjusting the current display and/or audio settings to the maximum possible display and/or audio settings.

According to one embodiment, the method may further include determining a price for adjusting the current display and/or audio setting, wherein prompting the user includes providing a price level for respective display and/or audio settings.

According to a further embodiment, the price level is in proportion to an improvement of display and/or audio settings incurred by the respective display and/or audio settings.

A further embodiment includes receiving a selection of display and/or audio settings from the user and applying the selected display and/or audio settings to the computing device.

According to another embodiment, prompting the user includes displaying a first graphical indicator that is slidable by the user between a first and a second extreme position, said first position corresponding to a minimum possible display setting of the computing device and said second position corresponding to a maximum possible display setting of the computing device, said first graphical indicator indicating said current display settings.

In another embodiment, prompting the user includes displaying a second graphical indicator slidable by the user between a first and a second extreme position, said first position corresponding to a minimum possible audio setting of the computing device and said second position corresponding to a maximum possible audio setting of the computing device, said first graphical indicator indicating said current audio settings.

According to yet another embodiment, detecting current display settings includes detecting a screen size of the computing device.

A further aspect of the disclosure includes a system of adapting quality for presenting content on a computing device, comprising: a first component adapted for detecting current display and/or audio settings of the computing device; a second component adapted for detecting maximum possible display and/or audio settings of the computing device; and a third component adapted for prompting a user of the computing device, in response to determining a difference between the current and the maximum possible display and/or audio settings, for adjusting the current resolution and/or audio quality settings to the maximum possible display and/or audio settings.

According to an embodiment, the system further includes a fourth component adapted for determining a price for adjusting the current display and/or audio setting, wherein the third component is further adapted for providing a price level for respective display and/or audio settings, said price level obtained from said fourth component.

According to a further embodiment, the price level is in proportion to an improvement of display and/or audio incurred by the respective display and/or audio settings.

A further embodiment includes a fifth component adapted for receiving a selection of display and/or audio settings from the user and for applying the selected display and/or audio settings to the computing device.

Another embodiment includes that the third component is further adapted for displaying to the user a first graphical indicator that is slidable by the user between a first and a second extreme position, said first position corresponding to a minimum possible display setting of the computing device and said second position corresponding to a maximum possible display setting of the computing device, said first graphical indicator indicating said current display settings.

According to another embodiment, the third component is further adapted for displaying to the user a second graphical indicator slidable by the user between a first and a second extreme position, said first position corresponding to a minimum possible audio setting of the computing device and said second position corresponding to a maximum possible audio setting of the computing device, said first graphical indicator indicating said current audio settings.

Still further, an embodiment is disclosed wherein the first component is further adapted for detecting a screen size of the computing device.

### BRIEF DESCRIPTION OF THE DRAWINGS

FIG. 1 is a flow diagram of a process in accordance with a method of the present disclosure;

FIG. 2 is a block diagram illustrating a graphical user interface in accordance with the present disclosure; and

FIG. 3 is a block diagram illustrating a system in accordance with the present disclosure.

### DETAILED DESCRIPTION

The present disclosure describes a method and a system of adapting quality for presenting content on a computing device. Throughout this document, quality for presenting content refers to display and/or audio quality settings. Display settings may include settings regarding resolution and/or screen size. Resolution refers to pixel density per area unit, such as 100×100 pixels per inch. Screen size refers to an overall number of pixels displayed on a screen, such as 1024×768 pixels. Concepts presented herein may be applied to other issues of quality, such as color or contrast, and may include properties such as stereo, virtual reality and three-dimensional representation of data.

Quality is discussed herein with respect to display settings of a computing device screen and/or audio hardware of a computing device. However, quality shall not be construed as being restricted to these terms, as aspects of the disclosure may use the quality term as referring to color, contrast, and other hardware and software factors of a computing device that may increase a user's experience when watching or listening to content on a computing device. In particular, quality as referred to herein may refer to a combination of multiple factors contributing to such experience.

Properties of consuming, such as watching or listening to, content may vary significantly depending on properties of a computing device. They may also vary due to a level of quality served to the user. For example, a media file containing a movie may be displayed with less resolution than is possible on the device; a media file containing a song may vary with regard to sound quality, such as encoding bit depth, and may be served and/or played with less bit depth than is possible on the device. In both cases, quality may be reduced even though the media file includes sufficient content for rendering at higher quality.

Aspects of the disclosure include a method of adapting quality for presenting content on a computing device, comprising: detecting current display and/or audio settings of the computing device; detecting maximum possible display and/or audio settings of the computing device; and in response to determining a difference between the current and the maximum possible display and/or audio settings, prompting a user of the computing device for adjusting the current display and/or audio settings to different display and/or audio settings.

Presenting content on a computing device may refer to displaying a film at a specific resolution and screen size, and to rendering corresponding sound of the film. Presenting content may also refer to any other kind of representing content, including rendering a graphical user interface (GUI) or rendering a web site.

Detecting current display settings may refer to consulting graphics hardware of a computing device, such as a graphics card, for current settings, said settings comprising screen size and resolution of a screen of the computing device. Alternatively or in addition, detecting current display settings may include detecting a bit depth used for the screen.

Detecting current audio settings may include consulting audio hardware, such as a sound card, for current settings, said settings reflecting a current bit depth used for rendering sound. Alternatively or in addition, detecting audio settings may include identifying a compression level of audio data rendered on the computing device.

Likewise, detecting maximum possible display settings may include consulting graphics hardware for maximum possible display settings, such as a maximum possible screen size or resolution the screen of the computing device can display. Detecting maximum possible audio settings could include consulting audio hardware for maximum possible audio settings, such as a maximum bit depth for sound encoding.

Subsequent to determining such information, embodiments of the disclosure may include determining a difference between the current and the maximum possible display and/or audio settings. This determination may be based on comparing the aforementioned factors, such as comparing whether a maximum possible resolution is higher than a current resolution.

According to embodiments of the disclosure, a difference may be determined in a case in which the compared values significantly differ. For example, both values may be considered as not deviating from one another if the difference is within a tolerance threshold.

Such determining of a difference may be performed with regard to current and maximum resolution and/or screen size, with regard to current audio settings and maximum audio settings, and even with regard to only one of such aspects. For example, current quality may be regarded as differing from a maximum possible setting if only one of display and audio settings is determined to differ between current and maximum possible values.

In response to determining such a difference, a user of the computing device may be prompted for adjusting the current display and/or audio settings to the maximum possible display and/or audio settings. Alternatively, the user may be prompted to adjust current display and/or audio settings to one of a plurality of values between current and maximum values. In some embodiments, the user may be prompted to adjust quality to a respective next level out of multiple discrete levels between current and maximum possible quality.

According to a particular embodiment, prompting the user may include determining a price for adjusting the current display and/or audio setting, wherein prompting the user includes providing a price level for respective display and/or audio settings. Embodiments of the disclosure may include providing multiple prices along with multiple possible steps for adjusting quality. For example, a graphical indicator with multiple consecutive quality levels may be presented, and each level may be labelled with the price required for adjusting to the respective level.

In one embodiment, the price level is in proportion to an improvement of display and/or audio quality incurred by the respective display and/or audio settings. In another embodiment, prices are in a decreasing order, such that a price for a first quality upgrade is higher than for a subsequent upgrade. Still further, individual prices for respective consecutive quality upgrades may be higher than a single price for a single quality upgrade comprising multiple quality levels. In combination or additionally, prices may increase with time and may be indicated to the user as increasing with time. For example, a given price for upgrading quality to maximum possible settings may only be valid for a predefined time, such as 24 hours, but may be indicated as increasing by a specific factor depending on time thereafter.

A selection of quality settings, such as display and/or audio settings, may be received from the user in response to prompting him or her with available quality levels. Subsequently, selected display and/or audio settings may be applied to the computing device. Applying these settings may include changing screen size and/or resolution and/or audio bit depth.

Prompting the user may be performed via an interactive dialog, such as a GUI, comprising one or more interactive controls. In one embodiment, these controls may include a first graphical indicator of a quality level. For example, the first graphical indicator may comprise a slider, a spinner, a drop-down list, or other controls suitable for enabling a user to select a value from a list or range of values. For example, a slider may be used which includes a graphical element that is slidable by the user between a first and a second extreme position. The first position may correspond to a minimum possible quality setting, such as a minimum possible resolution of a screen of the computing device, and the second position may correspond to a maximum possible quality setting, such as a maximum possible resolution of the screen. The position of the graphical element may indicate a current quality setting, such as a current resolution setting.

If a resolution is to be presented in said interactive dialog, only a few resolutions may be available. In this case, a drop-down list may be adequate to indicate the available resolutions. A slidable element as discussed above may be suitable if a range of successive values is to be presented. In one embodiment, the choice of an adequate control may be made automatically depending on the range of values available for selection.

In certain embodiments, multiple interactive controls corresponding to respective quality settings may be displayed. In one example, one control may be displayed for setting a resolution or screen size and a second control may be displayed for setting an audio quality setting. All such controls may have in common that they display a minimum setting, a maximum setting, and a current setting, wherein the minimum and maximum settings may be obtained from querying hardware components of the computing device, such as graphics hardware and/or audio hardware, whereas the current settings may be obtained from querying values stored by an operating system of the computing device. In one embodiment, current settings may include querying a resolution or a screen size of the computing device. Current settings may alternatively depend on a value stored for the respective user currently logged on to the computing device. If no predefined value exists, a default value may be used. In one embodiment, this default value may be set by a manufacturer or may be obtained from a remote server.

Another embodiment of the disclosure comprises a system of adapting quality for presenting content on a computing device. In one embodiment, the system may comprise a first component adapted for detecting current display and/or audio quality settings of the computing device. This first component may be implemented as a software module or program, or may be implemented as a hardware component in communication with an operating system of the computing device. The first component may be further adapted for detecting a screen size of the computing device, and more generally to detect current quality settings of the computing device. The first component may perform any of the steps discussed above with regard to detecting current settings.

The system may further comprise a second component adapted for detecting maximum possible display and/or audio quality settings of the computing device. The second component may be implemented in hardware and/or software and may be part of an operating system or in communication with an operating system.

Further, the system may comprise a third component adapted for prompting a user of the computing device. In particular, the third component may prompt the user in response to determining a difference between the current and the maximum possible display and/or audio settings. In one embodiment, the third component may be adapted to display a GUI comprising one or more interactive controls for indicating minimum, maximum, and current quality settings. For example, a respective such control may be displayed for each setting. Alternatively, a single interactive control may be displayed, said single interactive control reflecting a collective quality setting based on multiple quality aspects, such as screen size or resolution and audio quality. For example, each available resolution or screen size may be associated with a respective audio quality level, and a single interactive control may display several such associated resolutions or screen size and audio levels. Further, with regard to this example, a drop-down list may be presented which comprises multiple entries, each entry including both a respective display setting and an associated audio setting.

The third component may be further adapted for adjusting the current display and/or audio settings to the maximum possible display and/or audio settings. In one embodiment, the aforementioned drop-down list with associated display and audio settings may be used to obtain a selection entered by the user. Subsequently, the third component may apply the selected settings to the computing device, such as by configuring a graphics driver and/or an audio driver. Alternatively or in addition, an operating system may be called to apply the settings. In one embodiment, the new settings may be communicated to a remote server, said server adapted to collect settings of users at multiple computing devices. Instead of a drop-down box, the third component may be adapted to display any of the interactive controls discussed further above.

The system may further include a fourth component adapted for determining a price for adjusting the current display and/or audio setting. For example, each possible setting may be associated with a price, said price depending on the gap between a current setting and a setting to be selected. For example, a respective price may be associated with each available display and/or audio setting. When displaying a drop-down box with associated display and audio quality settings, a respective price may be displayed along with each entry in the drop-down box. In one embodiment, prices may be determined by the fourth component by contacting a remote server, such as the remote server adapted for storing current settings as discussed above. In this embodiment, selecting an entry of the drop-down box by the user will entail communicating the price associated with the selected setting to the remote server. The remote server may be adapted to subsequently handle charging the user with the price.

Prices for upgrades to a particular quality setting may be in proportion to an improvement of display and/or audio settings incurred by these respective settings. For example, adjusting a current setting to a next available higher resolution may incur a lower price than adjusting to the maximum possible resolution.

A fifth component may be included in the system, said fifth component adapted for receiving a selection of display and/or audio settings from the user and for applying the selected display and/or audio settings to the computing device. Such a selection may be received from a user selecting a value from one or more interactive controls displayed according to the discussions above. In this regard, the user may also be able to directly enter a desired value, such as a desired resolution, in an interactive text field. If the entered resolution is not available, the fifth component may automatically choose the next highest resolution, starting from the entered resolution.

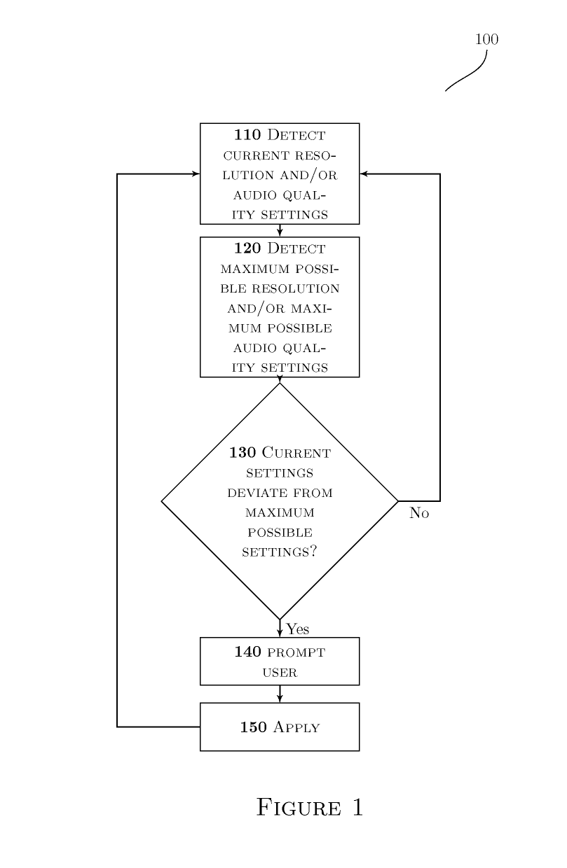

FIG. 1 illustrates a sample method of adapting quality for presenting content on a computing device according to embodiments of the disclosure. Method 100 may be executed in response to a user action, such as by a user selecting a corresponding menu item to launch the method. Alternatively, method 100 may be executed in response to detecting a change in hardware configuration, such as in response to a new screen being attached to the computing device. Method 100 may also be executed in response to detecting that the settings that are possible with an attached component have changed, such as by notification from a remote server with regard to an updated hardware specification.

Method 100 starts with detecting 110 current display and/or audio settings of the computing device. The detection may be performed by one or more calls to an operating system of the computing device and/or by querying graphics and/or audio drivers. In one embodiment, settings may be queried from a remote server rather than querying local components. This embodiment may be advantageous in cases where bandwidth usage is less restricted than local computing time. For example, method 110 may determine whether current bandwidth usage is above a first predefined threshold, and may further determine whether current processor and/or memory usage of the computing device is above a second predefined threshold. The remote server may be queried if the current bandwidth usage is below the first predefined threshold, and local querying may be applied otherwise.

Method 100 further includes detecting 120 maximum possible display and/or audio settings of the computing device. This may include querying graphics hardware of the computing device for a screen size and/or resolution that is possible with the computing device. Alternatively, detecting 120 may be based on querying a local database or a database stored on a remote server, said database mapping graphics hardware to technical settings that are possible with said graphics hardware.

Subsequently, method 100 determines 130 whether current display and/or audio settings differ from the maximum possible display and/or audio settings. Determining 130 such a difference may include comparing values corresponding to both settings. Determining 130 may further include determining whether the difference is significant. In one embodiment, a difference may be identified as significant if it is larger than a predefined threshold. In another embodiment, a difference may be identified as significant if it is larger than a standard deviation of previously determined differences. Determining whether a difference is significant may be advantageous in cases of a user repeatedly selecting and applying new settings, such as in cases where the user frequently changes resolutions. Determining significant differences may also be advantageous to decide whether an interactive dialog shall be displayed at all in response to detecting a difference between current and possible maximum settings. For example, the interactive dialog may only be displayed in case a significant difference is detected.

If no difference is determined, method 100 may return to step 110 discussed above. In one embodiment, the method 100 continues at step 110 after a predefined waiting time. In another embodiment, method 100 may continue at step 110 in response to determining a change in hardware configuration, such as detecting that a different or additional screen has been attached to the computing device.

If a difference is determined, the user may be prompted 140 for adjusting the current display and/or audio settings to the maximum possible display and/or audio quality settings. Prompting the user may include displaying an interactive dialog with interactive controls which enable the user to select alternative display and/or audio settings. Examples of such dialogs were discussed further above. The controls may be adapted to enable the user to adjust settings to a higher level that does not necessarily correspond to the maximum possible setting. In one embodiment, the user may be enabled to increase settings but not to decrease them. In another embodiment, the user may be enabled to increase or decrease a setting. This may be advantageous for enabling the user to save computational costs, such as to save graphics rendering costs and/or audio rendering costs. For example, the user may choose a lower resolution in order to accelerate graphics rendering on an older computing device.

One or more selected settings may be received by means of said interactive dialog. These settings may be applied 150 to the computing device, such as by requesting an operating system to reconfigure graphics drivers and/or audio drivers. In addition to applying 150 the settings, they may be communicated to a remote server for further storage.

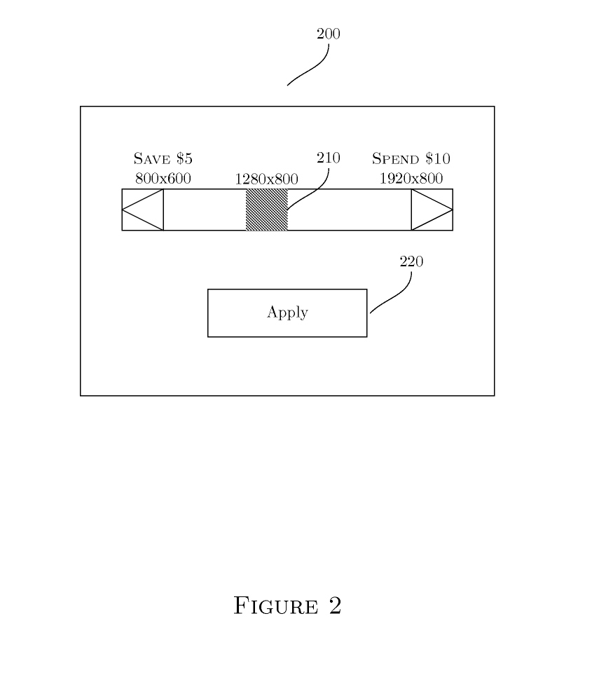

FIG. 2 illustrates a sample interactive dialog 200 for prompting the user as described above. Interactive dialog 200 is illustrated with a slidable control 210 and a button 220 labelled “Apply.” Instead of or in addition to slidable control 210, other controls may be presented, including drop-down boxes and other controls as discussed earlier in this document.

Slidable control 210 is illustrated with a first extreme position indicating a minimum possible screen size of 800×600 pixels, and with a second extreme position indicating a maximum possible screen size of 1920×800 pixels. A current screen size is indicated as 1280×800 pixels by sliding control 210. In the illustrated embodiment, prices for selecting extreme positions are indicated. For example, the user may save $5 by selecting the minimum possible screen size of 800×600 pixels, and may have to spend $10 by selecting the maximum possible screen size of 1920×800 pixels. In other embodiments, absolute prices may be indicated. In further embodiments, additional available screen sizes may be indicated between current and extreme positions. Still further, resolutions may be indicated instead of or in addition to screen sizes. In yet another embodiment, resolutions and/or screen sizes may be associated with respective audio settings. Still further, audio settings may be displayed in place of display settings, or may be displayed in a second interactive control in the interactive dialog 200.

Upon making a selection, the user may press or click the Apply button 220 in order to have his or her settings applied. Settings are applied to the computing device according to any of the steps discussed earlier herein.

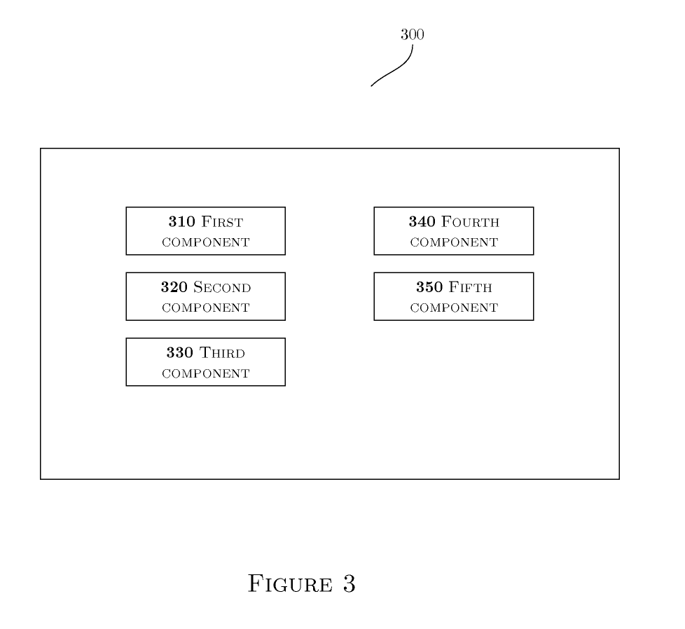

FIG. 3 illustrates an example system 300 for adapting quality of presenting content on a computing device. System 300 includes first, second, third, fourth, and fifth components 310 to 350. The functionality of the components corresponds to the functionality of the components discussed above. Certain components may be omitted and their functionality be performed by one of the other components. In one embodiment, a single component may perform all of the discussed functionality. System 300 may be connected to a remote server for communicating settings, such as for notifying the remote server of a change in current settings, or for querying the remote server for maximum possible settings regarding installed hardware. In one embodiment, the remote server may be contacted in response to determining that a hardware component was added to or removed from the computing device.

Although the present disclosure and its advantages have been described in detail, it should be understood that various changes, substitutions and alterations can be made therein without departing from the spirit and scope of the disclosure as defined by the appended claims.

The embodiments of the invention in which an exclusive property or privilege is claimed are defined as follows:

1. A method of adapting quality for presenting content on a computing device, comprising:
detecting current display and/or audio settings of the computing device;
detecting maximum possible display and/or audio settings of the computing device; and
in response to determining a difference between the current and the maximum possible display and/or audio settings, prompting a user of the computing device for adjusting the current display and/or audio settings to different display and/or audio settings.

2. The method of claim 1, further including determining a price for adjusting the current display and/or audio settings, wherein prompting the user includes providing a price level for respective display and/or audio settings.

3. The method of claim 2, wherein the price level is in proportion to an improvement of display and/or audio settings incurred by the respective display and/or audio settings.

4. The method of claim 1, further including receiving a selection of display and/or audio settings from the user and applying the selected display and/or audio settings to the computing device.

5. The method of claim 1, wherein prompting the user includes displaying a first graphical indicator slidable by the user between a first and a second position, said first position corresponding to a minimum possible display setting of the computing device and said second position corresponding to a maximum possible display setting of the computing device, said first graphical indicator indicating said current display setting.

6. The method of claim 1, wherein prompting the user includes displaying a second graphical indicator slidable by the user between a first and a second position, said first position corresponding to a minimum possible audio setting of the computing device and said second position corresponding to a maximum possible audio setting of the computing device, said first graphical indicator indicating said current audio setting.

7. The method of claim 1, wherein detecting current display settings includes detecting a screen size of the computing device.

8. A system of adapting quality for presenting content on a computing device, comprising:
a first component adapted for detecting current display and/or audio settings of the computing device;
a second component adapted for detecting maximum possible display and/or audio settings of the computing device; and
a third component adapted for prompting a user of the computing device, in response to determining a difference between the current and the maximum possible display and/or audio settings, for adjusting the current display and/or audio settings to different display and/or audio settings.

9. The system of claim 8, further including a fourth component adapted for determining a price for adjusting the current display and/or audio setting, wherein the third component is further adapted for providing a price level for respective display and/or audio settings, said price level obtained from said fourth component.

10. The system of claim 9, wherein the price level is in proportion to an improvement of display and/or audio settings incurred by the respective display and/or audio settings.

11. The system of claim 8, further including a fifth component adapted for receiving a selection of display and/or audio settings from the user and for applying the selected display and/or audio settings to the computing device.

12. The system of claim 8, wherein the third component is further adapted for displaying to the user a first graphical indicator slidable by the user between a first and a second position, said first position corresponding to a minimum possible display setting of the computing device and said second position corresponding to a maximum possible display setting of the computing device, said first graphical indicator indicating said current display setting.

13. The system of claim 8, wherein the third component is further adapted for displaying to the user a second graphical indicator slidable by the user between a first and a second position, said first position corresponding to a minimum possible audio setting of the computing device and said second position corresponding to a maximum possible audio setting of the computing device, said first graphical indicator indicating said current audio settings.

14. The system of claim 8, wherein the first component is further adapted for detecting a screen size of the computing device.
